(19) United States
(12) Patent Application Publication
(10) Pub. No.: US 2013/0120887 A1
(43) Pub. Date: May 16, 2013

(54) PROTECTION DEVICE FOR LITHIUM BATTERY ASSEMBLY

(71) Applicant: FU-CHIEH CHEN, Taichung (TW)

(72) Inventor: FU-CHIEH CHEN, Taichung (TW)

(21) Appl. No.: 13/603,430

(22) Filed: Sep. 5, 2012

(30) Foreign Application Priority Data
Nov. 16, 2011 (TW) 100221674

(51) Int. Cl. H02H 3/00

(52) U.S. Cl. 361/62

(57) ABSTRACT

A protection device for battery assembly includes a battery unit having multiple secondary Lithium batteries and the battery unit is electrically connected with a detection-control unit which is electrically connected to a by-pass which is a charge/discharge circuit. The detection-control unit has a voltage detection circuit and a micro controller unit to detect output voltage of the battery unit. A receiving device is electrically connected to the detection-control unit to receive wireless signals from a remote controller. The receiving device transmits signals to the detection-control unit. An emitting device is electrically connected to the detection-control unit to send signals to the remote controller when the battery unit has abnormal voltages. The battery unit is monitored and controlled by the detection-control device.

### FIELD OF THE INVENTION

The present invention relates to a secondary Lithium battery assembly, and more particularly, to a protection and anti-theft device for the Lithium battery assembly which cuts off the power according to the voltage of the battery unit to protect the vehicle from being stolen.

### BACKGROUND OF THE INVENTION

The conventional secondary Lithium battery can discharges and be re-charged, and are welcomed for the high energy density, stably discharging feature, repeat re-charged, low self-discharging and long term of life. The conventional secondary Lithium battery is suitable for being cooperated with appliances operated by D.C. power source, such as cellular phones, laptops and portable electronic devices.

When the secondary Lithium battery is used for the power source, if the electric energy is not supplied in time before it runs out, the Lithium battery may be damaged or even gat flame or even explosion.

Furthermore, the conventional secondary Lithium battery is only protected by a single feature to prevent the conventional secondary Lithium battery from being overly charged or discharged. When the conventional secondary Lithium battery is used for vehicles, it is important to avoid the conventional secondary Lithium battery from cutting the circuit suddenly so as to protect the safety of the driver and the passengers.

The present invention intends to provide a protection device for the Lithium battery assembly.

### SUMMARY OF THE INVENTION

The present invention relates to a protection device for battery assembly and comprises a battery unit having multiple secondary Lithium batteries and the battery unit is electrically connected with a detection-control unit which is electrically connected to a by-pass which is a charge/discharge circuit. The detection-control unit has a voltage detection circuit and a micro controller to detect output voltage of the battery unit. A receiving device is electrically connected to the detection-control unit to receive wireless signals from a remote controller. The receiving device transmits signals to the detection-control unit. An emitting device is electrically connected to the detection-control unit to send signals to the remote controller when the battery unit has abnormal voltages.

The primary object of the present invention is to provide a battery assembly wherein the voltages of the battery unit are monitored and controlled to protect the appliances using the battery units and the battery unit itself.

Another object of the present invention is to provide a battery assembly wherein the battery unit can be cut off by the detection to the voltages of the battery unit, the status of the vehicle using the battery unit so as to prevent the vehicle from being stolen, while the by-pass allows the computer system of the vehicle to be functioned normally.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the diagram of the battery assembly of the present invention;

FIG. 2 is a flow chart showing the detection-control unit of the battery assembly of the present invention;

FIG. 3 shows the diagram of the second embodiment of the battery assembly of the present invention;

FIG. 4 is a combination view of FIG. 4A and FIG. 4B, illustrates the flow chart of the sensing processes of the vibration sensor in the second embodiment of the battery assembly of the present invention;

FIG. 5 is the flow chart showing the operation of remote controller of the second embodiment of the battery assembly of the present invention, and

FIG. 6 is the flow chart showing the sensing processes of the temperature sensor in the third embodiment of the battery assembly of the present invention.

### DETAILED DESCRIPTION OF THE PREFERRED EMBODIMENT

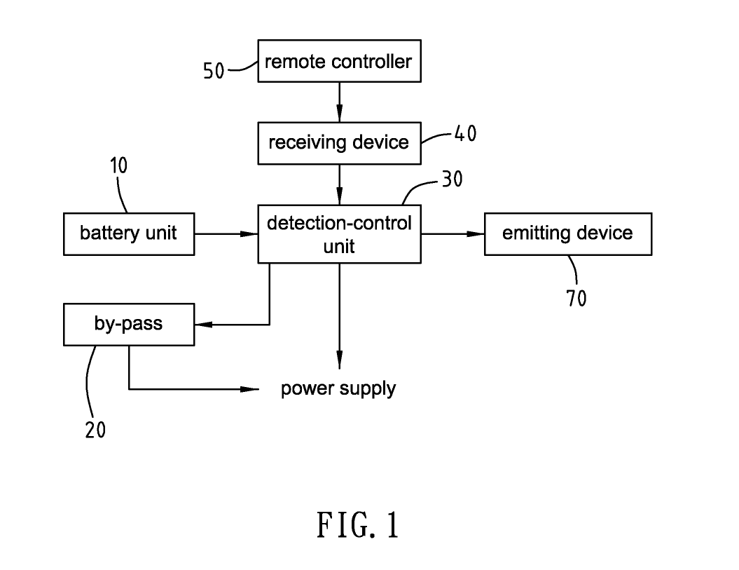

Referring to FIG. 1, the battery assembly of the present invention comprises a battery unit 10, a by-pass 20, a detection-control unit 30, a receiving device 40, a remote controller 50 and an emitting device 70. The battery unit 10 comprises multiple secondary Lithium batteries and is electrically connected with the detection-control unit 30. The detection-control unit 30 controls the battery unit 10 to provide electric power to the appliance. The by-pass 20 is a charge/discharge circuit and electrically connected to the detection-control unit 30. The by-pass 20 stores power by the battery unit 10 via the detection-control unit 30 so that the by-pass 20 can discharge to the appliance. The detection-control unit 30 comprises a voltage detection circuit and a micro controller unit so as to detect output voltage of the battery unit 10. The micro controller unit controls the status of supplying power to the appliance by the result of the voltage detection circuit, so as to protect the appliance. The receiving device 40 is electrically connected to the detection-control unit 30 so as to receive wireless signals from the remote controller 50. The receiving device 40 transmits signals to the detection-control unit 30 so as to control the power supply status from distance. The emitting device 70 is electrically connected to the detection-control unit 30 so as to send signals to the remote controller 50 to acknowledge the user when the battery unit 10 has abnormal voltages.

The detection-control unit 30 detects the output voltages of the battery unit 10 to judge the performance of the battery unit 10 and to protect the battery unit 10 when the voltages are high or low.

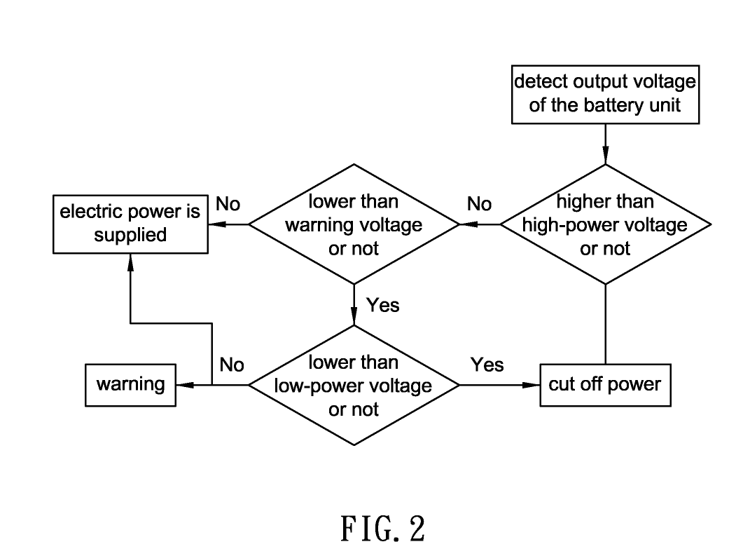

Referring to FIGS. 1 and 2, the detection-control unit 30 is operated as the following steps:

Step 1: when the output voltage of the battery unit 10 detected by the detection-control unit 30 is lower than the high-power voltage, the next step is taken. When the output voltage of the battery unit 10 detected by the detection-control unit 30 is higher than the high-power voltage for consecutive ten seconds, the detection-control unit 30 cuts power. The appliance cannot get the power and the detection-control unit 30 controls the emitting device 70 to send signals the remote controller 50 to acknowledge the users. By this way, the battery unit 10 is protected from overly discharging. After that the output voltage of the battery unit 10 is detected to be higher than the high-power voltage and the power is cut, the output voltage of the battery unit 10 is continuously monitored by the detection-control unit 30. When the output voltage of the battery unit 10 is lower than the high-power voltage for consecutive ten seconds, the next step is taken. In the meanwhile, the emitting device 70 stops to emit signals. When the battery unit 10 is used in a vehicle, the high-power voltage is 15.2V.

Step 2: when the output voltage of the battery unit 10 is lower than the high-power voltage, the detection-control device 30 judges whether the output voltage of the battery unit 10 is lower than the warning voltage. When the output voltage of the battery unit 10 is higher than warning voltage, electric power is supplied to the appliance. When the output voltage of the battery unit 10 is lower than the warning voltage, the emitting device 70 sends signals to the remote controller 50 to acknowledge the users that the power of the battery unit 10 is going to run out. The users have time to respond to the situation. When the output voltage of the battery unit 10 is lower than warning voltage, the output voltage of the battery unit 10 is checked if it is lower than low-power voltage. If the output voltage of the battery unit 10 is lower than the low-power voltage, the detection-control unit 30 cuts the power and the appliance cannot get the power from the battery unit 10 while the battery unit 10 still has power so that the battery unit 10 is protected from overly discharging. In the meanwhile, the by-pass 20 provides power to the computer and important parts of the vehicle to avoid all of the settings from lost. When the battery unit 10 is used as the vehicle battery unit, the warning voltage is 12.8V and the low-power voltage is 9.2V.

When the vehicle installed the battery unit 10 is not in use, the remote controller 50 controls the detection-control unit 30 to cut off the power so that the vehicle is protected from being stolen. The cut-off status of the battery unit 10 can be activated by using the remote controller 50. When using the remote controller 50 to activate the battery unit 10, the receiving device 40 receives signals from the remote controller 50 and transmits signals to the detection-control unit 30, the detection-control unit 30 proceeds the steps 1 and 2. When the output voltage of the battery unit 10 is higher than the high-power voltage or lower than the low-power voltage, the cut-off status cannot be re-activated by the use of the remote controller 50 so as to protect the appliance and the battery unit 10. The by-pass 20 provides power to the computer of the vehicle. Furthermore, when the cut-off status is built by using the remote controller 50, the detection-control unit 30 detects that the output voltage of the battery unit 10 is lower than the warning voltage, the emitting device 70 sends signals to acknowledge the user that the power of the battery unit 10 is going to run out.

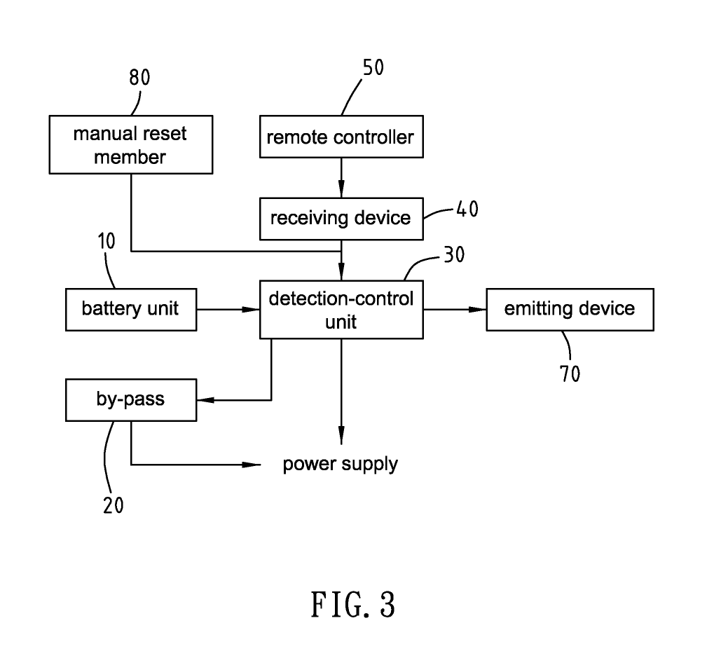

The second embodiment is disclosed in FIG. 3 and the difference from the first and second embodiments is that a manual reset member 80 is used and the detection-control unit 30 further has a vibration sensor (not shown) which detects vibration from the appliances, and the detection-control unit 30 cuts the power according results of the vibration sensor. The manual reset member 80 is used to re-connect the power.

When the second embodiment is used as a vehicle battery, when the engine is in idle status, the vibration sensor senses the vibration of different levels. When the vehicle is not in use and the engine is turned off, no vibration is detected by the vibration sensor. The detection-control unit 30 cuts the power according results of the vibration sensor and proceeds the steps 1 and 2 as mentioned before.

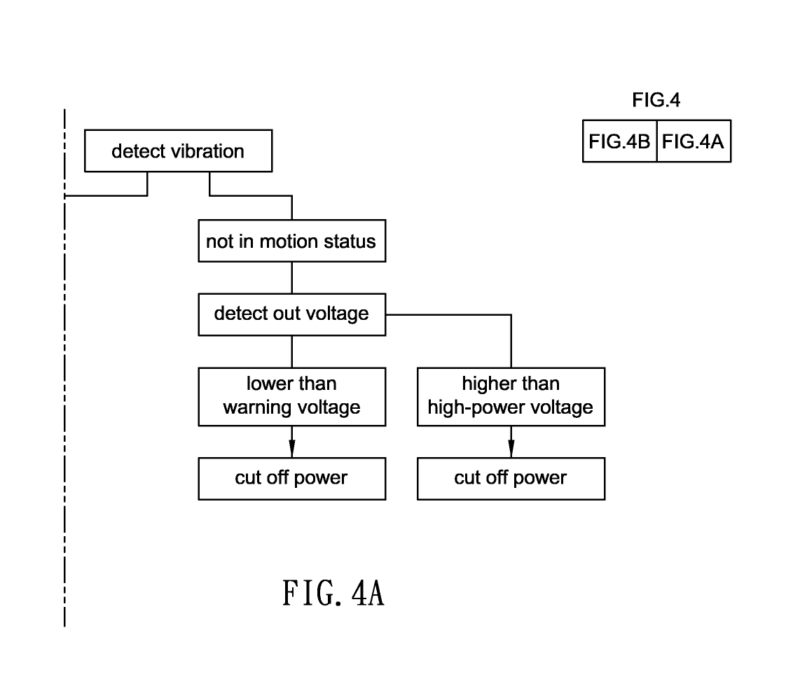

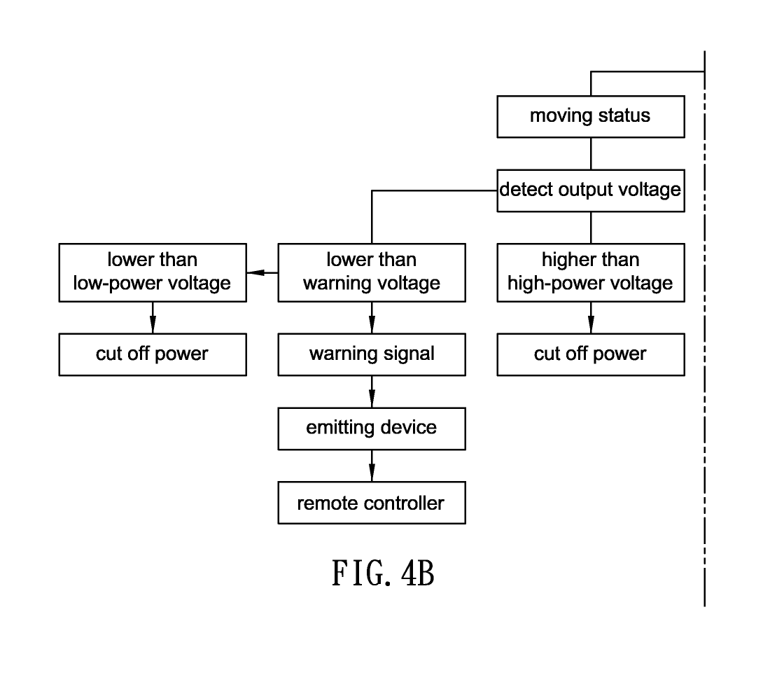

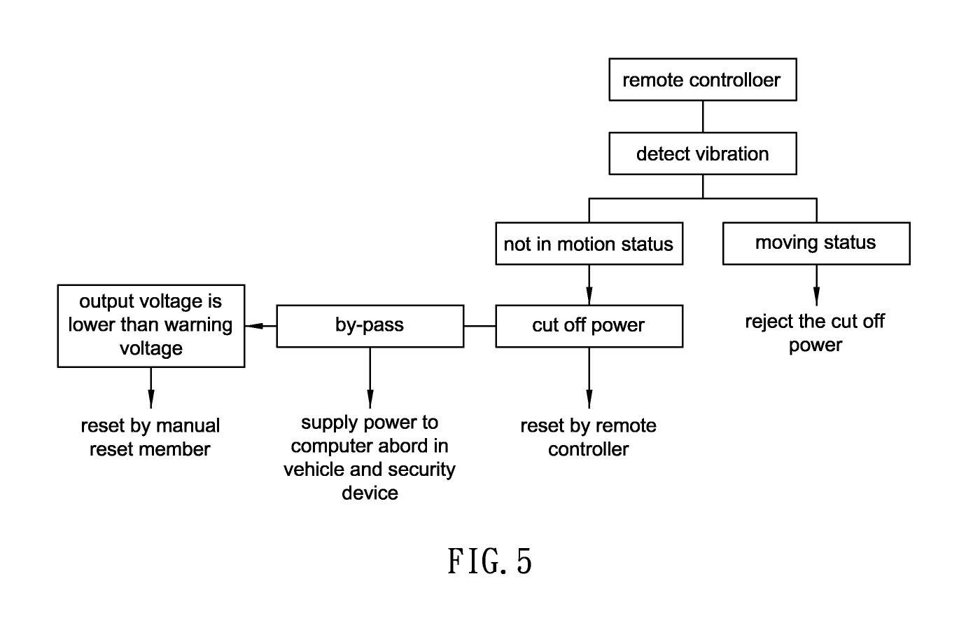

When the vehicle is not in motion as shown in FIGS. 3 to 5, if the output voltage of the battery unit 10 is lower than the warning voltage, or higher than the high-power voltage, the detection-control device 30 cuts off the power and the appliance cannot get power from the battery unit 10 which is protected from running out its energy. When the detection-control device 30 detects that the output voltage of the battery unit 10 is lower than the warning voltage, and cuts off the power, the users may reset the connection by the manual reset member 80, the remained power in the battery unit 10 is able to start the engine. The battery unit 10 is charged by the operation of the engine. However, when using the manual reset member 80 to reconnect the circuit, the engine uses out the remained power in the battery unit 10, and when the output voltage of the battery unit 10 is lower than the low-power voltage, the detection-control device 30 cuts off the power. Under this situation, the cut-off status cannot be released by using the manual reset member 80 again so as to protect the battery unit 10. It is noted that when using the manual reset member 80 to release the cut-off status, the remained power in the battery unit 10 can only provide three times of trial of re-starting the engine.

When the vehicle is moving, and the output voltage of the battery unit 10 is higher than the high-power voltage, the detection-control device 30 cuts off the power. When the output voltage of the battery unit 10 is lower than the warning voltage, the detection-control device 30 controls the emitting device 70 to send signals to the remote controller 50 to acknowledge the users so that the users have time to respond. Furthermore, when the output voltage of the battery unit 10 is lower than the warning voltage, the detection-control device 30 cuts off the power so that the battery unit 10 keeps the remained power so that the manual reset member 80 is able to be operated to release the cut-off status. When the remote controller 50 sends signals to cut off the power of the vehicle, if the vibration sensor senses vibration, then the detection-control device 30 judges that the vehicle is moving and rejects the cut-off demand from the remote controller 50. This prevents mis-operation to the vehicle due to unintentional touch to the remote controller 50.

The third embodiment discloses that the detection-control unit 30 has a temperature sensor (not shown) which detects temperature of the battery unit 10, and the detection-control unit 30 cuts the power according results of the temperature sensor to protect the battery unit 10.

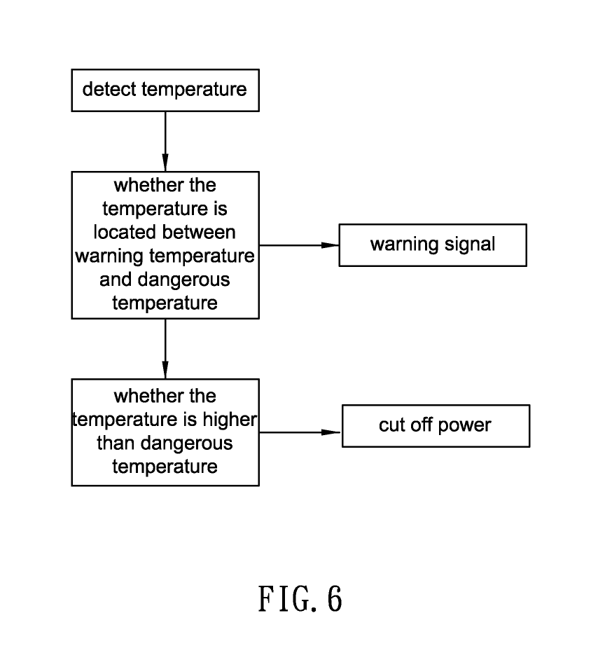

As shown in FIG. 6, when the sensed temperature from the temperature sensor is located between the warning temperature and the dangerous temperature, the detection-control device 30 demands the emitting device 70 to send signals to the remote controller 50 to acknowledge the users. When the sensed temperature from the temperature sensor is higher than the dangerous temperature, the detection-control device 30 cuts off the power to avoid the temperature from continuously increasing and therefore protects the battery unit 10.

While we have shown and described the embodiment in accordance with the present invention, it should be clear to those skilled in the art that further embodiments may be made without departing from the scope of the present invention.

What is claimed is:

1. A protection device for battery assembly, comprising:
a battery unit having multiple secondary Lithium batteries and electrically connected with a detection-control unit, a by-pass being a charge/discharge circuit and electrically connected to the detection-control unit, the detection-control unit having a voltage detection circuit and a micro controller unit so as to detect output voltage of the battery unit, and
a receiving device electrically connected to the detection-control unit and receiving wireless signals from a remote controller, the receiving device transmitting signals to the detection-control unit, an emitting device electrically connected to the detection-control unit so as to send signals to the remote controller when the battery unit has abnormal voltages.

2. The device as claimed in claim 1, wherein the output voltage of the battery unit is higher than the high-power voltage for consecutive ten seconds, the detection-control unit cuts power and the emitting device sends signals to acknowledge the users.

3. The device as claimed in claim 2, wherein the high-power voltage is 15.2V.

4. The device as claimed in claim 1, wherein when the output voltage of the battery unit is lower than warning voltage, the detection-control unit cuts power and the emitting device sends signals to the remote controller to acknowledge the users.

5. The device as claimed in claim 4, wherein when the output voltage of the battery unit is lower than low-power voltage, the detection-control unit cuts power, the low-power voltage is lower than the warning voltage.

6. The device as claimed in claim 5, wherein the warning voltage is 12.8V and the low-power voltage is 9.2V.

7. The device as claimed in claim 1 further comprising a manual reset member, the detection-control unit having a vibration sensor which detects vibration from the appliances, the detection-control unit cuts the power according results of the vibration sensor, the manual reset member re-connecting the power.

8. The device as claimed in claim 1, wherein the detection-control unit has a temperature sensor which detects temperature of the battery unit, the detection-control unit cuts the power according results of the temperature sensor to protect the battery unit.
